(19) United States
(12) Patent Application Publication
(10) Pub. No.: US 2010/0179000 A1
(43) Pub. Date: Jul. 15, 2010

(54) GOLF BALL MOLD AND GOLF BALL

(75) Inventors: Kaichiro Nakajima, Chichibu-shi (JP); Katsunori Sato, Chichibu-shi (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE SPORTS CO., LTD., Tokyo (JP)

(21) Appl. No.: 12/354,489

(22) Filed: Jan. 15, 2009

(51) Int. Cl. A63B 37/00; B29C 33/42

(52) U.S. Cl. 473/351; 425/116

(57) ABSTRACT

The invention provides a golf ball mold composed of a plurality of mold parts which removably mate to form a hollow interior spherical cavity having a cavity wall with a plurality of dimple-forming protrusions thereon and which have a parting surface that is formed in a convex shape and a concave shape matching the convex shape. All or some of the dimple-forming protrusions are formed at positions at least about 0.03 mm away from an outside edge of a convex portion of the parting surface. The mold eliminates the possibility that molding flash projecting out from the parting surface of the mold will enter the dimples, as a result of which the dimples are not affected by the trimming of flash. Golf balls manufactured with such a mold are able to effectively manifest the aerodynamic performance of dimples tightly and uniformly arranged on the surface of the ball.

### BACKGROUND OF THE INVENTION

The present invention relates to a golf ball mold for one-piece golf balls, solid golf balls composed of a core encased by one or more cover layer, thread-wound golf balls and the like. The invention relates also to golf balls manufactured using such a mold.

Molds for molding golf balls are generally composed of a plurality of parts which are removably mated to each other, and manufacture golf balls by feeding a golf ball molding material to a cavity that forms at the interior of the mold when these mold parts are mated. The parting surface of such a multi-part mold is often of rectilinear shape without concavities and convexities. Parting surfaces having such a rectilinear shape are usually coincident with the equator on the surface of the golf ball. Thus, in golf balls molded with such a mold, dimples are not formed on the equator which coincides with the parting surface; instead, a somewhat wide great circle forms at the equator.

However, in a golf ball having at the equator a wide great circle across which there lie no dimples, it is difficult to achieve a uniform arrangement of dimples on the spherical surface of the ball. This leads to a lack of uniformity in the aerodynamic symmetry of the ball, giving rise to a variability in the flight performance depending on differences in the place of impact when the ball is played.

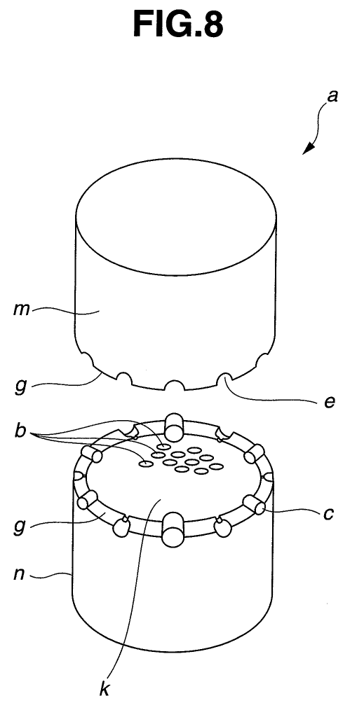

Innovations have thus been made to provide dimples which lie across the equator so as to eliminate a wide great circle on the equator. For example, JP-A 10-127826 discloses a golf ball mold having a construction wherein, as shown in FIG. 8, an upper mold half m and a lower mold half n are removably mated to form at the mold interior a hollow spherical cavity, and a plurality of dimple-forming protrusions are disposed on the wall of the cavity. In addition, the parting surface g on the upper and lower mold halves is formed in a concavo-convex shape. To provide dimple-forming protrusions situated so as to lie across the parting line in the concavo-convexly shaped region, a plurality of semicircular grooves e which, when the upper and lower mold halves are mated, define a plurality of circular holes corresponding to the dimple diameter are formed, and cylindrical pins c having dimple-shaped ends are inserted loosely into the circular holes.

In addition to the foregoing, numerous disclosures have been made wherein, to have dimples lie across the golf ball equator, the parting surface of the mold is given a shape that is concavo-convex rather than rectilinear, with all or part of a dimple-forming protrusion being disposed on each convex portion thereof (e.g., JP-A 06-143349, JP-A 08-173576, JP-A 11-070186, JP-A 11-137727, JP-A 2001-170217, JP-A 2001-187172, JP-A 2002-159598, JP-A 2004-089549, JP-A 2006-212057, JP-A 2007-136182, JP-A 2007-159715 and JP-A 2007-268265).

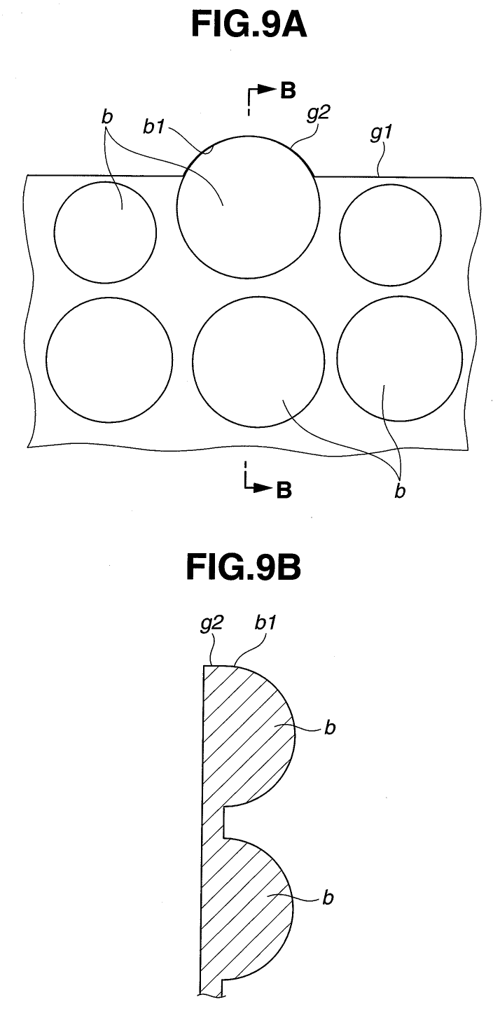

However, in conventional golf ball molds, when the parting surface of the mold is given a concavo-convex shape, either the convex portions are themselves dimple-forming protrusions or dimple-forming protrusions are formed near the convex portions. That is, as shown in FIGS. 9A and B, the outside edge g2 of a convex portion of the parting surface g substantially coincides with the peripheral edge b1 at the base of a dimple-forming protrusion b. As a result, after injection molding, the molding defect known as flash which projects out from the mold parting surface may make its way into the dimple.

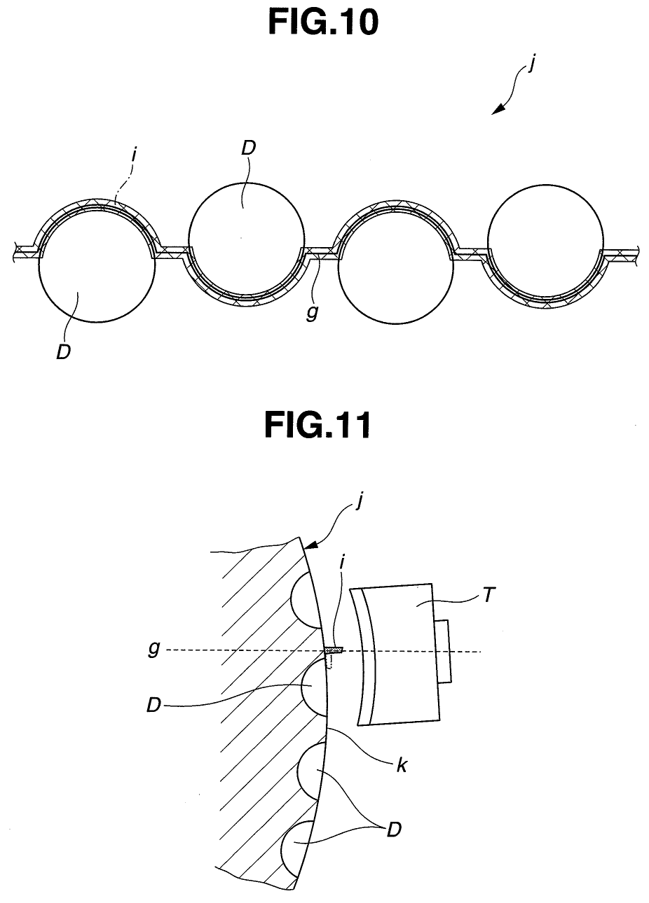

More specifically, referring to FIG. 10, which is a schematic diagram showing, on the surface j of an injection-molded golf ball, a parting surface g having a concavo-convex or wavy shape and dimples D located nearby, after a cover resin material or the like has been injection-molded, molding flash i having a uniform width of several microns forms along the parting surface g. Because dimple-forming protrusions are present near the parting surface g of the mold, there is a possibility that some of the molding flash i will enter the recesses of the injection-molded dimples D. Here, the molding flash i projects outward in the form of a ring along and on top of the seam line of the ball. As seen in the cross-sectional view in FIG. 11, the flash i is formed in the shape of a rod directed toward the outside of the ball surface J. When the molding flash i is to be removed with a trimming machine T, there is a possibility that, during such trimming, the rod-shaped flash i will bend under the pressure applied by the trimming machine T and enter into the dimple D in the manner indicated by the dashed line in the diagram. Although the trimming face of the trimming machine comes into contact with the land areas k of the ball surface j and is able to remove flash present on the ball surface, because the trimming face does not reach well into the dimple recesses, it has been difficult to fully remove flash present within the dimples. Dimple function is thus compromised by the presence of flash, resulting in a loss of aerodynamic properties.

In cases where the parting surface of the mold has convex portions thereon, the size and position of dimples situated within such convex portions are subject to limitations according to the shape of the convex portions. As a result, there is less degree of freedom in the dimple arrangement, making it more difficult to tightly and uniformly arrange dimples on the surface of the ball and thus manufacture a golf ball having sufficient aerodynamic properties. In addition, the mold has an inferior durability.

### SUMMARY OF THE INVENTION

It is therefore an object of the present invention to provide a golf ball mold which eliminates the possibility that molding flash projecting out from the parting surface of the mold will enter the dimples and is thus able to manufacture golf balls that effectively manifest the aerodynamic performance of dimples tightly and uniformly arranged over the surface of the ball.

To achieve the above object, the invention provides the following golf ball mold and golf ball.

[1] A golf ball mold comprising a plurality of mold parts which removably mate to form a hollow interior spherical cavity having a cavity wall with a plurality of dimple-forming protrusions thereon and which have a parting surface that is formed in a convex shape and a concave shape matching the convex shape, wherein all or some of the dimple-forming protrusions are formed at positions at least about 0.03 mm away from an outside edge of a convex portion of the parting surface.

[2] The golf ball mold of [1], wherein the convex portion has a height from a mold parting line in a range of from about 0.5 mm to about 3 mm.

[3] The golf ball mold of [1], wherein a dimple-forming protrusion occupies a proportion of the convex portion of from 30 to 98%.

[4] The golf ball mold of [1] which has a dimple-forming protrusion at a position equidistant from the outside edge of the convex portion.

[5] The golf ball mold of [1], wherein a mating portion between the convex portion or concave portion and the parting surface has a curved surface.

[6] The golf ball mold of [5], wherein the curved surface in the mating portion between the convex portion or concave portion and the parting surface has a radius of curvature of from about 0.1 mm to about 1.0 mm.

[7] The golf ball mold of [1], wherein a plurality of the convex portions or concave portions are arranged at equal intervals along an entire circumference of the parting surface.

[8] A golf ball which is molded using the above golf ball mold.

In the golf ball mold of the invention, a plurality of dimple-forming protrusions are disposed on the wall of the mold cavity, and the parting surface of the mold is formed in a convex shape and a concave shape corresponding to the convex shape. Moreover, all or some of the dimple-forming protrusions are formed in convex portions of the mold parting surface. In this invention, the dimple-forming protrusions are formed at positions at least about 0.03 mm away from the outside edges of the convex portions of the parting surface. As a result, flash does not enter into the dimples (of the injection-molded article) corresponding to the dimple-forming protrusions, enabling the golf ball to effectively manifest the aerodynamic performance of the dimples.

In the specification, the terms “mold parting surface” and “parting line” are defined as follows.

“Mold parting surface” refers to an area of contact between a pair of mold halves when an upper mold half mates with a lower mold half. In the invention, the mold parting surface has convex portions, and thus includes also concave portions.

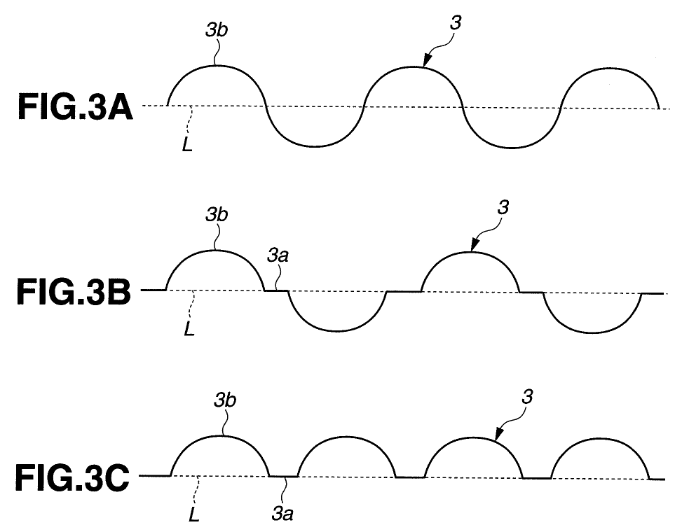

“Parting line” refers to a line which serves as a reference for the mating of the upper mold half with the lower mold half. The parting line is rectilinear in shape. That is, referring to FIG. 3, in the present invention, although the mold parting surface has convex portions 3b, rectilinear portions 3a other than the convex portions coincide with the parting line L.

### BRIEF DESCRIPTION OF THE DIAGRAMS

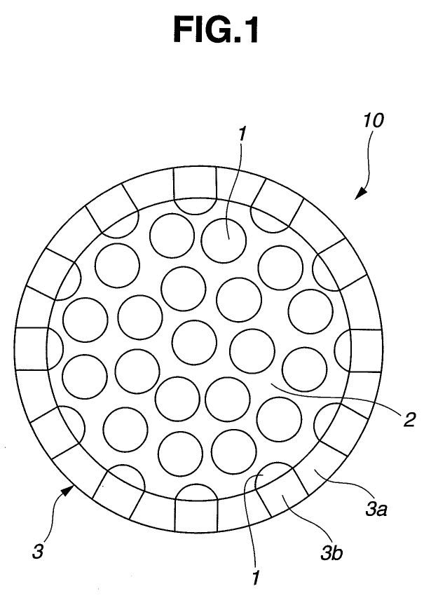

FIG. 1 is a plan view of an injection mold (lower mold half) according to an embodiment of the invention.

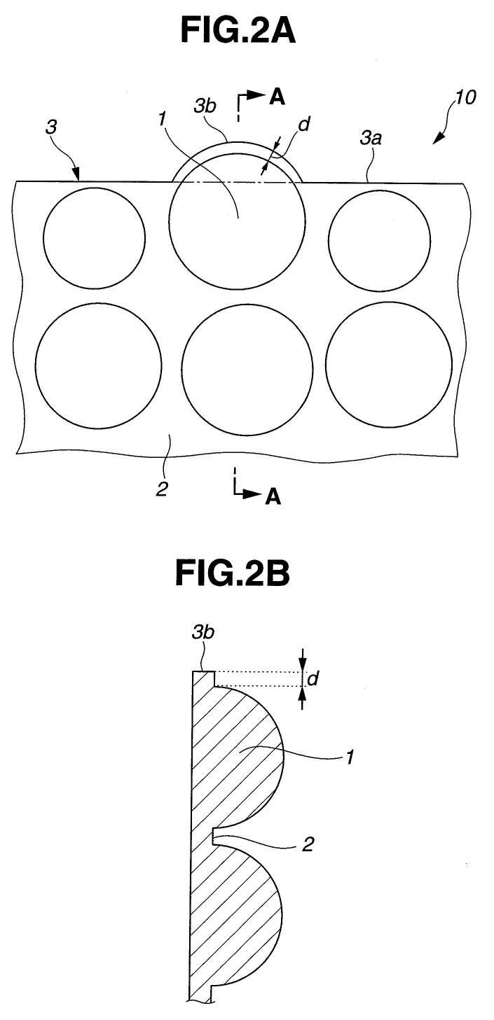

FIG. 2A is a partial schematic view showing a top end portion of the lower mold half in FIG. 1, and FIG. 2B is a cross-sectional view taken along A-A in FIG. 2A.

FIG. 3 shows examples of the shape of the mold parting surface.

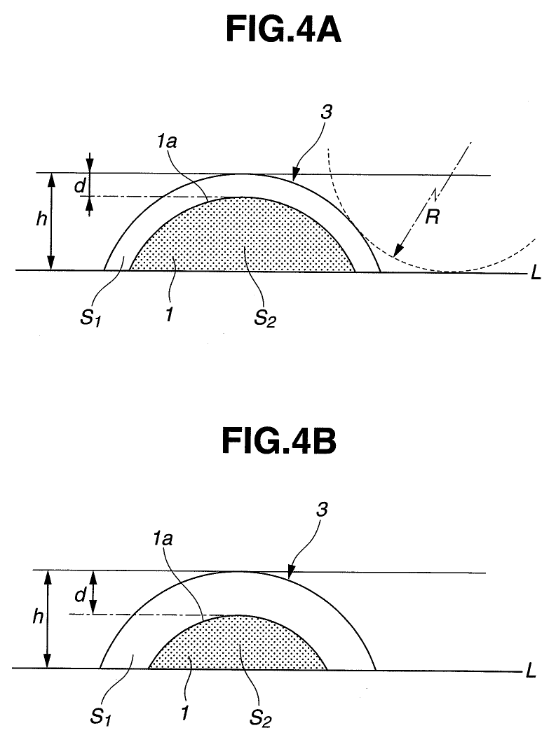

FIG. 4 illustrates the proportion of the surface area of a convex portion of the mold parting surface which is occupied by a dimple-forming protrusion.

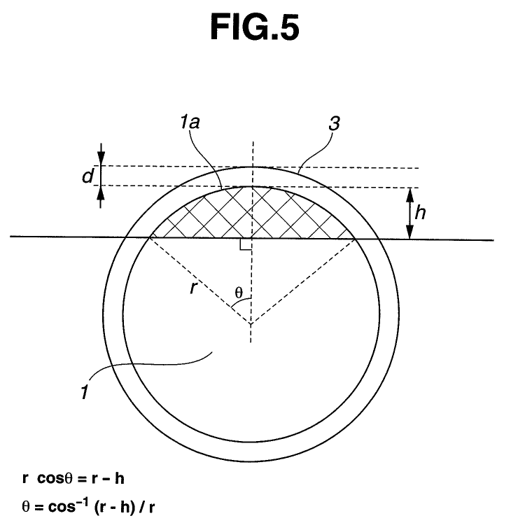

FIG. 5 is a schematic diagram illustrating the relationship between the distance of a convex portion from the parting line, the dimple radius of a dimple-forming protrusion, and the distance of the dimple-forming protrusion from the outside edge of the convex portion.

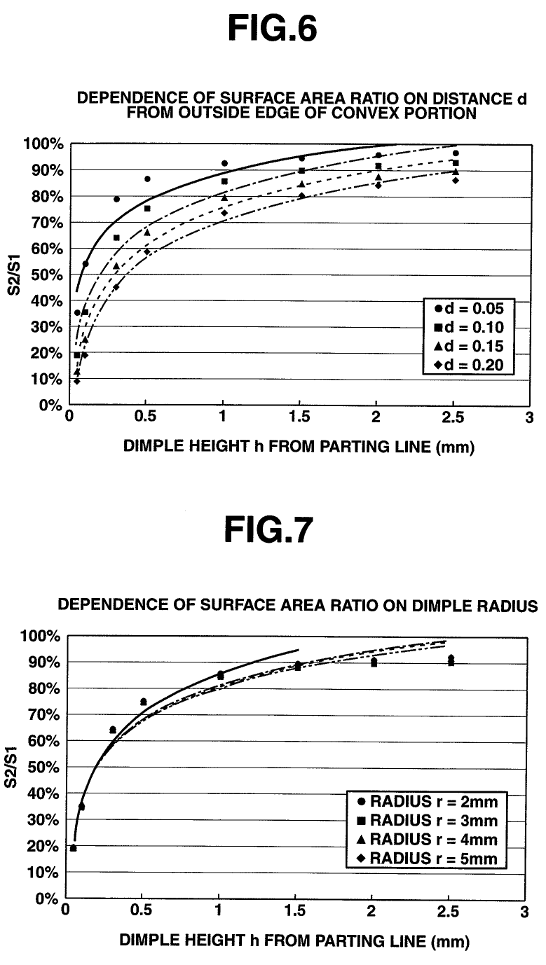

FIG. 6 is a graph showing the dependency of the surface area ratio S₂/S₁ on the distance from the convex portion to the dimple-forming protrusion.

FIG. 7 is a graph showing the dependency of the surface area ratio S₂/S₁ on the dimple radius.

FIG. 8 is a schematic perspective view showing a conventional golf ball mold.

FIG. 9 is a partial schematic view showing the relative positions of a parting surface having a convex portion and dimple-forming protrusions in a conventional golf ball mold, and FIG. 9B is a cross-sectional view taken along B-B in FIG. 9A.

FIG. 10 is a schematic view showing the seam line on the surface of an injection-molded golf ball and dimples located near the seam line.

FIG. 11 is a schematic view illustrating the trimming of molding flash from the surface of an injection-molded golf ball.

### DETAILED DESCRIPTION OF THE INVENTION

The golf ball mold of the invention is described more fully below in conjunction with FIGS. 1 to 5.

FIG. 1 is a plan view of an injection mold (lower mold half) 10 according to an embodiment of the invention. The mold is a vertically separating two-part mold which is equally divided into upper and lower halves so as to have a parting surface at an equatorial position of a spherical mold cavity; only the lower half of the mold is shown. A hemispherical cavity 2 having a plurality of dimple-forming protrusions 1 is formed at the interior of the lower mold half. The hemispherical cavity 2 has, at an outside peripheral edge at the top end thereof, a mold parting surface 3 with convex shapes thereon. In FIG. 1, the symbol 3a represents rectilinear portions and the symbol 3b represents convex portions. Although not shown, the parting surface 3 of the upper mold half has concave shapes which match the convex portions 3b of the lower mold half 10.

FIG. 2A is a partial schematic view showing a top end portion of the lower mold half 10 in FIG. 1. In this diagram, a dimple-forming protrusion 1 is situated at a position exactly a distance d from the outside edge of a convex portion 3b at the parting surface 3. A cross-sectional view of this is shown in FIG. 2B. That is, the outside edge of the convex portion 3b and the base of the dimple-forming protrusion 1 do not coincide and are instead separated by exactly a distance d, resulting in the formation of a step.

The material used here in the mold, such as the lower mold half 10, may be any suitable known material without particular limitation.

The mold must have at least one parting surface 3, but may be constructed so as to have two or more parts. The fewer the number of mold parting surfaces 3, the greater the degree to which limitations on the dimple configuration can be reduced. On the other hand, a higher number of mold parting surfaces 3 facilitates the release of the golf ball from the mold, enabling the efficiency of manufacturing operations to be improved. In the present invention, it is desirable for the mold to have one parting surface 3. That is, as shown in FIGS. 1 and 2, the use of a two-part mold having an upper half and a lower half is preferred.

As shown in FIG. 1, the mold parting surface 3 may be situated at the equatorial position in the spherical cavity. Alternatively, the parting surface may be situated at a position offset by a specific distance from the equator. Having the parting surface situated at a position offset a specific degree from the equator is particularly advantageous in that the releasability of the golf ball from the mold can be enhanced.

The convex portion 3b of the parting surface refers herein to a region of the parting surface that rises up from the rectilinear portion of the parting surface 3 indicated by the dash-dot line in FIG. 2A. All or part of a dimple-forming protrusion 1 is formed in this region. In FIG. 2, part of a dimple-forming protrusion 1 is formed therein. Within the convex portion 3b region of the parting surface, the proportion occupied by the dimple-forming protrusion 1 is suitably selected according to the diameter, shape or other characteristics of the dimple-forming protrusion 1.

In FIG. 1, twelve convex portions 3b are arranged uniformly on the parting surface 3. The number of convex portions 3b on a single parting surface 3, while not subject to any particular limitation, is preferably from 4 to 20, and more preferably from 6 to 16.

The above convex portions 3 (or concave portions corresponding thereto) may be arranged in any way along the entire circumference of the parting surface, although arrangement at equally spaced intervals in the manner shown in FIG. 1 is desirable.

The shape of the parting surface 3, while not subject to any particular limitation, is preferably one where the edge is defined by connecting together curvilinear segments and/or rectilinear segments. Examples are shown in FIGS. 3A, B and C. The parting surface in FIG. 3A exhibits, near the parting line L, a concavo-convex shape obtained by connecting convex portions 3b formed in alternation on the upper and lower mold halves, These convex portions 3b are of a hemispherical shape similar to the dimple-forming protrusions 1. The parting surfaces in FIGS. 3B and C are each composed of hemispherical convex portions 3b similar to the dimple-forming protrusions 1 and rectilinear segments 3a which coincide with the parting line L. In FIG. 3B, convex portions 3b are formed in alternation on the upper and lower mold halves, whereas in FIG. 3C, convex portions 3b are formed only on the lower mold half.

The convex portions 3b of the parting surface may be given a shape that is circularly arcuate, or may describe part of a trapezoidal, rectangular, triangular or other shape. In the present invention, to improve the durability of the mold, it is preferable for the convex portions 3b to have a shape which is substantially circularly arcuate. It is especially preferable for the shape of the convex portions 3b to conform to the shape of the protruding portions of dimples which intersect the parting line L, and to be substantially similar in shape to the base of the dimple-forming protrusions 1. This makes it easy to induce the formation of molding flash at a position located at a sufficient remove from the dimple-forming protrusions 1. By placing the convex portions 3b a fixed distance d from the dimple-forming protrusions 1, the convex portions 3b can be made smaller, which helps reduce limitations on the dimple configuration and makes it possible to enhance mold durability.

In the present invention, the distance d from the outside edges of the convex portions 3b to the dimple-forming protrusions 1 is set to at least about 0.03 mm. The lower limit is preferably at least about 0.05 mm, and the upper limit is preferably not more than about 0.3 mm, and more preferably not more than about 0.2 mm. A distance d which does not satisfy the above range will become a major cause of poor mold part durability and also will become a major cause for the entry of flash into dimples when trimming is carried out after injection molding, and is thus undesirable. Moreover, it is preferable to have the dimple-forming protrusions 1 situated at positions which are substantially equidistant from the outside edges of the convex portions 3b. That is, it is preferable for a dimple-forming protrusion 1 inside a convex portion 3b to have a shape which follows and is similar to the outside edge of the convex portion 3b, and to be situated so that the intervening distance d therebetween remains substantially equal.

At the parting surface 3, in some cases, as shown in FIG. 3, the interval between one convex portion 3b and another convex portion is connected by a rectilinear segment 3a, although a smooth curvilinear segment may be suitably used in place of the rectilinear portion for such connection. For example, as shown in FIG. 4, by connecting one convex portion 3b with another convex portion 3b using a curvilinear segment (indicated by the dotted line in the diagram) having a constant radius of curvature R, mold damage when mating the upper mold half with the lower mold half can be minimized, enabling the durability of the mold as a whole to be improved. The above-indicated radius of curvature R, while not subject to any particular limitation, is preferably in a range of from about 0.1 to about 1.0 mm.

As shown in FIG. 4, the height h to which the convex portions 3b on the mold parting surface 3 rise up from the parting line L serving as the reference line for the parting surface 3 is preferably at least about 0.5 mm, and more preferably at least about 1 mm, but preferably not more than about 3 mm, more preferably not more than about 2.5 mm, and even more preferably not more than about 2 mm. Setting the height h to which the convex portions 3b rise to a higher value increases the surface area over which molding flash arises and becomes a major cause of molding defects. Therefore, by setting the height h in the above-indicated range, the trimming step can be simplified and molding defects can be prevented.

Also, referring to FIG. 4, the surface area S₁ enclosed by the parting line L and the outside edge of the convex portion 3b, as seen from the center of the spherical surface, while not subject to any particular limitation, is preferably from about 0.5 to about 16 mm², more preferably from about 0.8 to about 15 mm², and even more preferably from about 1.0 to about 14 mm².

The surface area S₂ enclosed by the parting line L and the base of the dimple-forming protrusion 1, while not subject to any particular limitation, is preferably from about 0.2 to about 15 mm², more preferably from about 0.5 to about 14 mm², and even more preferably from about 0.8 to about 13 mm².

In addition, the surface area ratio expressed as S₂/S₁×100(%), while not subject to any particular limitation, is preferably from about 30% to about 98%, more preferably from about 40% to about 96%, and even more preferably from about 50% to about 95%. By controlling the surface area S₂ and the surface area ratio S₂/S₁ in the above-indicated manner, the surface coverage by dimples on the ball surface can be controlled and molding defects can be prevented, enabling golf balls having excellent aerodynamic properties to be obtained. Moreover, because stable manufacture without causing molding defects is possible, the stability of the ball trajectory can be increased and the symmetry can be improved. Comparing FIGS. 4A and 4B, S₁ has the same surface area in both diagrams, but because S₂ is larger in FIG. 4A than in FIG. 4B, the surface area S₂/S₁ is higher in FIG. 4A. In this case, the dimple surface coverage on the ball can be made higher in FIG. 4A than in FIG. 4B, as a result of which molding flash does not form within the dimples and molding defects can be prevented. By contrast, in FIG. 4B, although molding flash does not form in the dimples, the arrangement of dimples near the parting line becomes more sparse, making it impossible to achieve a high dimple surface coverage, which is disadvantageous.

This S₂/S₁ surface area ratio varies considerably depending on the distance d from the outside edge of the convex portions 3b and the dimple diameter of the dimple-forming protrusions 1 situated within the convex portions 3b. FIG. 5 is a schematic diagram illustrating, in a case where a convex portion 3b and the base of a dimple-forming protrusion 1 have shapes that are part of mutually similar circles, the relationship between the distance h of the convex portion 3b from the parting line, the dimple radius r of the dimple-forming protrusion, and the distance d of the dimple-forming protrusion from the outside edge of the convex portion 3b. The graphs in FIGS. 6 and 7 were obtained from an examination, using the indicated relations, of the surface area ratio S₂/S₁ dependency at varying radii r or distances d.

The dimple D formed by the above dimple-forming protrusion 1 has a diameter of preferably from 1.5 to 6 mm, and more preferably from 2 to 5 mm. Moreover, the dimple D has a depth which, while not subject to any particular limitation, is preferably from 0.05 to 0.4 mm, and more preferably from 0.1 to 0.35 mm.

The dimples D have a surface coverage, which is the extent to which the dimples cover the surface of the ball, of preferably at least 70%. By placing dimples on the mold parting surface, the dimple surface coverage can be increased. The dimples D have a volume of preferably from 200 to 700 mm². By placing dimples on the mold parting surface, the dimple volume can be adjusted while maintaining the symmetry properties.

Although not particularly shown in the diagrams and explained, the injection mold of the invention generally has a plurality of injection gates which open out into the mold cavity 2. The construction of these gates, including such conditions as the positioning and number of gates and the injection pressure, are the same as that of injection mold gates used in conventional molds. For example, generally from 4 to 8 gates may be provided along the equator at positions on the mold mating plane which corresponds to the equator of the cavity 2. When a core sphere is placed in a mold and injection molding is carried out, the core sphere is supported with support pins. Such support pins may also be configured in the same way as in the prior art.

When golf balls are injection molded using the mold of the invention, the molding method and conditions used may be similar to those used with conventional molds. For example, in cases where two-piece solid golf balls are manufactured by injection molding a cover over a solid core, the upper and lower mold halves are removably mated, with a solid core positioned at the center of the cavity. Although not shown in the diagrams, a molding material capable of being used to mold conventional golf ball covers, such as a known ionomer resin, is injected in a molten state through the respective mold gates and into the cavity. After cooling and solidification, the upper and lower mold halves are separated, the molding is extracted and the gates are cut, following which flash is removed by trimming, thereby giving a golf ball. Alternatively, cover molding may be carried out by compression molding, in which case the method carried out may be similar to one used in the prior art. Because even compression molding results in the formation of flash along the golf ball equator, it is desirable to use the inventive mold in such a case as well is.

Although preferred embodiments have been described above in conjunction with the diagrams, the golf ball and golf ball mold of the invention are not limited by the diagrams and the above embodiments and may be suitably modified without departing from the spirit and scope of the present invention. For example, the shape, size and arrangement of the convex portions of the parting line are not limited to those specified in the foregoing embodiments and diagrams, and may be suitably modified and selected without departing form the spirit and scope of the invention.

As explained above, the golf ball mold of the invention eliminates the possibility that molding flash projecting out from the parting surface of the mold will enter the dimples, as a result of which the dimples are not affected by the trimming of flash. Golf balls manufactured with such a mold are able to effectively manifest the aerodynamic performance of dimples tightly and uniformly arranged on the surface of the ball.

1. A golf ball mold comprising a plurality of mold parts which removably mate to form a hollow interior spherical cavity having a cavity wall with a plurality of dimple-forming protrusions thereon and which have a parting surface that is formed in a convex shape and a concave shape matching the convex shape, wherein all or some of the dimple-forming protrusions are formed at positions at least about 0.03 mm away from an outside edge of a convex portion of the parting surface.

2. The golf ball mold of claim 1, wherein the convex portion has a height from a mold parting line in a range of from about 0.5 mm to about 3 mm.

3. The golf ball mold of claim 1, wherein a dimple-forming protrusion occupies a proportion of the convex portion of from 30 to 98%.

4. The golf ball mold of claim 1 which has a dimple-forming protrusion at a position equidistant from the outside edge of the convex portion.

5. The golf ball mold of claim 1, wherein a mating portion between the convex portion or concave portion and the parting surface has a curved surface.

6. The golf ball mold of claim 5, wherein the curved surface in the mating portion between the convex portion or concave portion and the parting surface has a radius of curvature of from about 0.1 mm to about 1.0 mm.

7. The golf ball mold of claim 1, wherein a plurality of convex portions or concave portions are arranged at equal intervals along an entire circumference of the parting surface.

8. A golf ball which is molded using the golf ball mold of claim 1.
